(19) United States
(12) Patent Application Publication
(10) Pub. No.: US 2025/0202114 A1
(43) Pub. Date: Jun. 19, 2025

(54) ELECTRONIC DEVICE

(71) Applicant: VIVO MOBILE COMMUNICATION CO., LTD., Guangdong (CN)

(72) Inventor: Yue QIN, Guangdong (CN)

(73) Assignee: VIVO MOBILE COMMUNICATION CO., LTD., Guangdong (CN)

(21) Appl. No.: 19/069,833

(22) Filed: Mar. 4, 2025

Related U.S. Application Data
(63) Continuation of application No. PCT/CN2023/115624, filed on Aug. 30, 2023.

(30) Foreign Application Priority Data
Sep. 5, 2022 (CN) 202211079301.9

(51) Int. Cl. H01Q 5/35; H01Q 1/52; H01Q 7/00; H01Q 9/04

(52) U.S. Cl. CPC H01Q 5/35; H01Q 1/521; H01Q 7/00; H01Q 9/0407

(57) ABSTRACT

This application discloses an electronic device, including an antenna cluster, where the antenna cluster includes at least two antennas arranged in sequence, each antenna corresponds to a feed point, the feed point is electrically connected to a feed structure, any two adjacent antennas of the at least two antennas are at least partially arranged in sleeving mode, and any two adjacent antennas of the at least two antennas are spaced apart.

### CROSS-REFERENCE TO RELATED APPLICATIONS

This application is a continuation application of PCT International Application No. PCT/CN2023/115624 filed on Aug. 30, 2023, which claims priority to Chinese Patent Application No. 202211079301.9, filed on Sep. 5, 2022, which is incorporated herein by reference in its entirety.

### TECHNICAL FIELD

This application pertains to the field of electronic technologies, and specifically relates to an electronic device

### BACKGROUND

With development of electronic technologies, functions that can be implemented on electronic devices increase continuously, resulting in increasingly high requirements on antennas of the electronic devices. Currently, to enable an electronic device to implement a plurality of functions, the electronic device usually needs to be provided with a plurality of independent antennas, and consequently, a volume of the electronic device is large.

### SUMMARY

This application is intended to provide an electronic device.

An embodiment of this application provides an electronic device, including an antenna cluster, where the antenna cluster includes at least two antennas arranged in sequence, each antenna corresponds to a feed point, the feed point is electrically connected to a feed structure, any two adjacent antennas of the at least two antennas are at least partially arranged in sleeving mode, and any two adjacent antennas of the at least two antennas are spaced apart.

### BRIEF DESCRIPTION OF DRAWINGS

The foregoing and/or additional aspects and advantages of this application will become apparent and comprehensible from the description of the embodiments with reference to the following drawings.

FIG. 1 is a schematic diagram of a structure of an electronic device according to an embodiment of this application;

FIG. 2 is a front view of the electronic device provided in FIG. 1 according to an embodiment of this application;

FIG. 3 is a schematic diagram of a structure of another electronic device according to an embodiment of this application;

FIG. 4 is a system efficiency diagram of the structure shown in FIG. 3 according to an embodiment of this application;

FIG. 5 is a schematic diagram of a structure of another electronic device according to an embodiment of this application;

FIG. 6 is a front view of the electronic device provided in FIG. 5 according to an embodiment of this application;

FIG. 7 is a schematic diagram of a structure of another electronic device according to an embodiment of this application;

FIG. 8 is a front view of the electronic device provided in FIG. 7 according to an embodiment of this application;

FIG. 9 is a schematic diagram of a structure of another electronic device according to an embodiment of this application;

FIG. 10 is a system efficiency diagram of the structure shown in FIG. 9 according to an embodiment of this application;

FIG. 11 is a schematic diagram of a structure of another electronic device according to an embodiment of this application;

FIG. 12 is a schematic diagram of a structure of another electronic device according to an embodiment of this application;

FIG. 13 is a schematic diagram of a structure of another electronic device according to an embodiment of this application;

FIG. 14 is a schematic diagram of a structure of another electronic device according to an embodiment of this application;

FIG. 15 is a schematic diagram of a structure of another electronic device according to an embodiment of this application;

FIG. 16 is a schematic diagram of a structure of another electronic device according to an embodiment of this application; and

FIG. 17 is a schematic diagram of a structure of another electronic device according to an embodiment of this application.

### DESCRIPTION OF EMBODIMENTS

The embodiments of this application are described in detail below. Examples of the embodiments are shown in the accompanying drawings, and the same or similar reference signs indicate the same or similar components or components with the same or similar functions. The embodiments described below with reference to the drawings are exemplary and only used to explain this application, but cannot be understood as a limitation of this application. All other embodiments obtained by a person of ordinary skill in the art based on the embodiments of this application without creative efforts shall fall within the protection scope of this application.

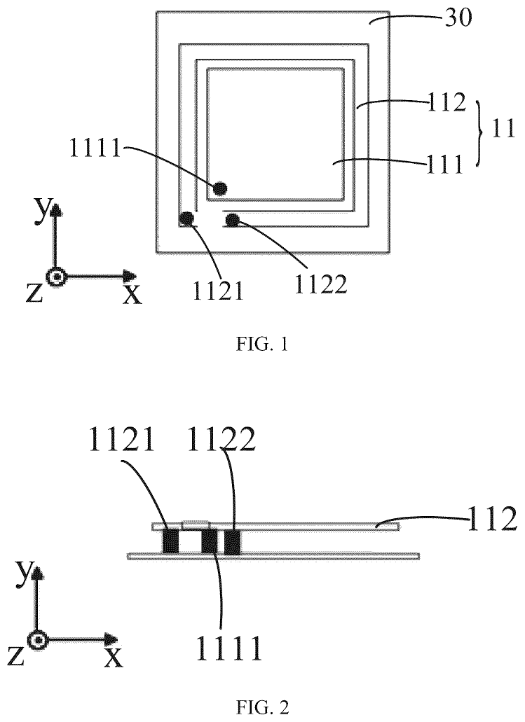

FIG. 1 is a schematic diagram of a structure of an electronic device according to an embodiment of this application. As shown in FIG. 1, the electronic device includes an antenna cluster, where the antenna cluster includes at least two antennas 11 arranged in sequence, each antenna corresponds to a feed point, the feed point is electrically connected to a feed structure, any two adjacent antennas of the at least two antennas 11 are at least partially arranged in sleeving mode, and any two adjacent antennas 11 of the at least two antennas 11 are spaced apart.

The sleeving arrangement may also be referred to as nesting. In other words, two adjacent antennas may be referred to as a first antenna and a second antenna, at least part of a structure included in the first antenna may be inserted in the second antenna, and the first antenna and the second antenna are spaced apart, that is, the first antenna and the second antenna are not in contact.

It should be noted that the structure included in the first antenna may be completely located in the second antenna, or part of the structure included in the first antenna is located in the second antenna, while another part of the structure included in the first antenna is located outside the second antenna.

For an operating principle of this embodiment of this application, refer to the following description.

Compared with a separate arrangement of one antenna in a position, in this embodiment, any two adjacent antennas 11 of the at least two antennas 11 are at least partially arranged in sleeving mode, that is, as many antennas 11 as possible may be arranged in the same position. Therefore, a quantity of antennas 11 in the electronic device is increased, a volume occupied by the at least two antennas 11 is reduced as much as possible, and further, a volume of the electronic device is reduced.

Operating frequency bands of any two antennas 11 of the at least two antennas 11 may be close (that is, a difference between the operating frequency bands may be less than a preset threshold). This can enhance radiation efficiency of the antennas 11 of the entire electronic device, and further enhance radiation performance of the antennas 11 of the entire electronic device. Alternatively, operating frequency bands of any two antennas 11 of the at least two antennas 11 may not be close (that is, a difference between the operating frequency bands may be greater than or equal to a preset threshold). This can increase radiation bandwidths of the antennas 11 of the entire electronic device and further enhance radiation performance of the antennas 11 of the entire electronic device.

It should be noted that when only part of the at least two antennas 11 is in an operating state, the remaining antenna 11 in a non-operating state may be used as a parasitic antenna of the foregoing antenna 11 in the operating state (that is, coupling between the antenna 11 in the non-operating state and the antenna 11 in the operating state), so that radiation performance of the electronic device can be further enhanced.

A sleeving arrangement mode of any two adjacent antennas 11 of the at least two antennas 11 is not limited herein. In an optional implementation, one antenna 11 of two adjacent antennas 11 may be completely arranged inside the other antenna 11 in sleeving mode, or in another optional implementation, one antenna 11 of two adjacent antennas 11 may be partially arranged inside the other antenna 11 in sleeving mode. In other words, part of a structure included in one antenna 11 may be located inside another antenna 11, and another part of the structure included in the one antenna 11 may be located outside the foregoing other antenna 11.

In addition, a type of each of the at least two antennas 11 may be the same as types of other antennas 11. In an optional implementation, each of the at least two antennas 11 may be a patch antenna, a loop antenna, a monopole antenna, or a planar inverted F-shaped antenna (PIFA).

Certainly, the type of each of the at least two antennas 11 may be different from the types of the other antennas 11. This is not specifically limited herein.

It should be noted that a shape of each of the at least two antennas 11 is not limited either herein. In an optional implementation, the shape of each of the at least two antennas 11 is the same, that is, the shape of each antenna 11 may be circular, oval, rectangular, square, rhombic, L-shaped, E-shaped, U-shaped, C-shaped, or the like.

In addition, at least part of the at least two antennas 11 may have different shapes.

It should be noted that an arrangement position of the antenna cluster on the electronic device is not limited herein. In an optional implementation, the antenna cluster may be arranged in an accommodating cavity formed and enclosed by a frame 20, a cover plate, and a main board of the electronic device, or the antenna cluster may be arranged on an inner wall of a cover plate, where the inner wall may be understood as a surface facing the main board.

In an optional implementation, there are a plurality of antenna clusters, and the plurality of antenna clusters are located in different positions of the electronic device.

Because the plurality of antenna clusters are arranged and arrangement positions of the plurality of antenna clusters are different, radiation performance of the electronic device can be enhanced, and radiation performance in each position of the electronic device is good.

In an optional implementation, the frame 20 of the electronic device may be a rectangular frame, a center position of the frame 20 may be used as a coordinate origin, a width and a length of the frame 20 of the electronic device may be used as an x-axis and a y-axis respectively, and a thickness direction of the electronic device (that is, a direction from a display screen to the cover plate) may be used as a z-axis to establish a rectangular coordinate system, so that the electronic device can be divided into four quadrants. The antenna cluster may be arranged in a first quadrant. Certainly, the antenna cluster may be arranged in a second quadrant, a third quadrant, or a fourth quadrant, and arrangement positions and a quantity of antenna clusters arranged in each quadrant are not limited herein.

In an optional implementation, the electronic device includes a main board, a cover plate, and a frame 20, where the main board and the cover plate are spaced apart, an accommodating cavity is formed and enclosed by the main board, the cover plate, and the frame 20, the antenna cluster is located in the accommodating cavity, the feed structure corresponding to each antenna 11 included in the antenna cluster is located on the main board, and a radiator of each antenna 11 included in the antenna cluster is arranged toward the cover plate.

It should be noted that, in an optional implementation, the main board and the cover plate may respectively abut against the frame 20, so that a volume of the accommodating cavity can be increased, and that sealing performance of the accommodating cavity can be enhanced.

When an operating frequency band of one antenna 11 included in the antenna cluster is not close to operating frequency bands of other antennas 11, that is, when the operating frequency band of the antenna 11 may be unique, a feed structure corresponding to the antenna 11 is a separate feed structure; or when an operating frequency band of one antenna 11 included in the antenna cluster is close to operating frequency bands of other antennas 11, the antenna 11 may share a same feed structure with the antennas 11 with close operating frequency bands, thereby reducing a quantity of feed structures and further reducing the volume of the entire electronic device.

The frame 20 may also be referred to as a middle frame or a metal frame, and the cover plate may be a non-metal cover plate. Because the cover plate is a non-metal cover plate, and the radiator of the antenna 11 is arranged toward the cover plate, a signal radiated by the radiator is not shielded by the cover plate, so that a phenomenon of poor radiation performance is avoided. This further ensures good radiation performance of the antenna.

In this implementation of this application, the accommodating cavity is formed and enclosed by the main board, the cover plate, and the frame 20, and the antenna cluster is located in the accommodating cavity, so that the accommodating cavity can protect the antennas 11 included in the antenna cluster. In addition, the radiator of each antenna 11 included in the antenna cluster is arranged toward the cover plate, so that the signal radiated by the radiator can be radiated to an external environment smoothly through the cover plate, and that a shielding effect of other components in the electronic device on the signal radiated by the radiator is reduced, thereby further enhancing radiation performance of the antenna 11 of the electronic device.

It should be noted that the quantity of antennas 11 included in the antenna cluster is not limited herein, and that the types of antennas 11 are not limited either herein.

In an optional implementation, referring to FIG. 1, the at least two antennas 11 include a first antenna 111 and a second antenna 112, and the first antenna 111 is at least partially arranged in the second antenna 112 in sleeving mode.

Because the antenna cluster includes the first antenna 111 and the second antenna 112, and the first antenna 111 is at least partially arranged in the second antenna 112 in sleeving mode, a volume of the antenna cluster is small, and the radiation performance of the electronic device is further enhanced.

In an optional implementation, referring to FIG. 1, FIG. 2, and FIG. 11, the first antenna 111 is a patch antenna, a first feed point 1111 is arranged in a first corner position of the first antenna 111, the second antenna 112 is a loop antenna, a second feed point 1121 and a first ground point 1122 are arranged at two ends of the second antenna 112 respectively, and any two of the first feed point 1111, the second feed point 1121, and the first ground point 1122 are adjacent and spaced apart.

The first ground point 1122 may be connected to a ground layer 30, and the first feed point 1111 and the second feed point 1121 may be electrically connected to a feed structure respectively.

Sizes of the patch antenna and the loop antenna are usually different. Therefore, usually, operating frequencies of the patch antenna and the loop antenna can be controlled to be different frequencies, thereby increasing the bandwidth of the antenna.

In this implementation of this application, the first antenna 111 is a patch antenna and the second antenna 112 is a loop antenna. In this way, the patch antenna and the loop antenna are combined, so that space is fully utilized, that is, it may be considered that the space for arranging the patch antenna and the loop antenna on the electronic device is relatively reduced, and further, the volume of the electronic device is reduced. In addition, because the patch antenna and the loop antenna are integrated in one position, the radiation performance of the antennas 11 of the electronic device is enhanced.

In addition, because any two of the first feed point 1111, the second feed point 1121, and the first ground point 1122 are adjacent to each other and spaced apart, the first feed point 1111, the second feed point 1121, and the first ground point 1122 can be arranged in a centralized manner. Compared with a distributed arrangement of the first feed point 1111, the second feed point 1121, and the first ground point 1122, the centralized manner can reduce usage of other space, that is, increase a volume of clearance space, thereby reducing interference on the radiation performance of the first antenna 111 and the second antenna 112, and enhancing the radiation performance of the first antenna 111 and the second antenna 112.

It should be noted that shapes of the patch antenna and the loop antenna are not limited herein. In an optional implementation, referring to FIG. 1, the patch antenna may be a rectangular patch antenna and the loop antenna may be a rectangular loop antenna; alternatively, the patch antenna may be a circular patch antenna and the loop antenna may be a circular loop antenna; alternatively, the patch antenna may be a rhombic patch antenna and the loop antenna may be a rhombic loop antenna. In other words, the shapes of the patch antenna and the loop antenna may be adapted, so that utilization of the space for arranging the patch antenna and the loop antenna on the electronic device can be higher.

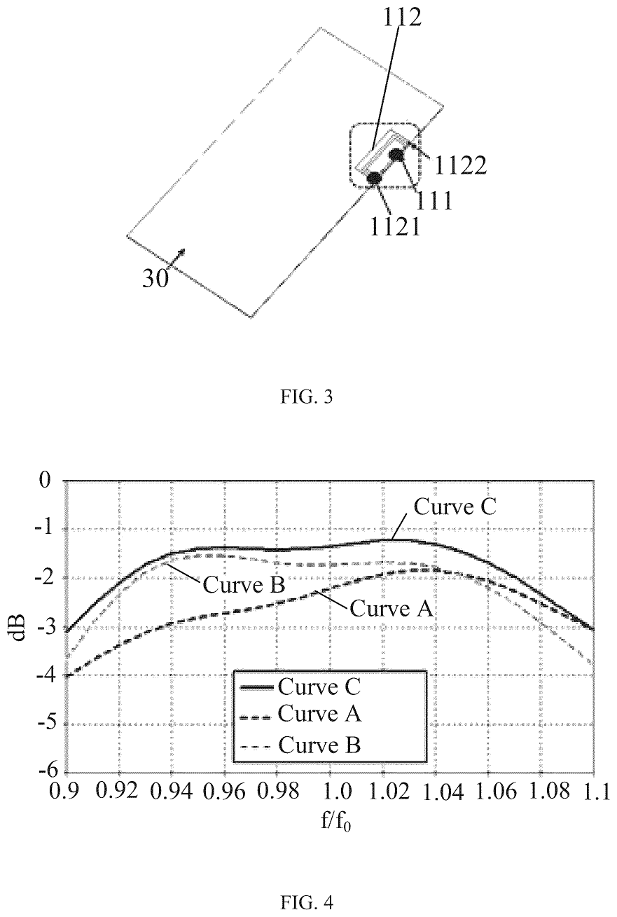

In another optional implementation, referring to FIG. 3, the patch antenna may be a rectangular patch antenna, and the loop antenna may be a C-shaped loop antenna, that is, the shapes of the patch antenna and the loop antenna may not be adapted, so that the arrangement of the patch antenna and the loop antenna can be more flexible. In addition, a combination of a patch antenna and a loop antenna in different shapes may be selected based on a shape of the space for arranging the patch antenna and loop antenna on the electronic device, to better adapt to the shape of the space for arranging the patch antenna and loop antenna on the electronic device.

In an optional implementation, referring to FIG. 4, in FIG. 4, curve A may refer to radiation efficiency of the second antenna 112 in the embodiment shown in FIG. 3, curve B may refer to radiation efficiency of the first antenna 111, and curve C may refer to overall radiation efficiency of the antenna cluster including the second antenna 112 and the first antenna 111. As can be learned from FIG. 4, a resonant frequency of the second antenna 112 is approximately 1.04 f₀, and a resonant frequency of the first antenna 111 is approximately 0.96 f₀. Based on amplitude weights and phases of ports for exciting the second antenna 112 and the first antenna 111, the antenna cluster achieves an approximate 1 dB efficiency improvement over the second antenna 112 of the same area within a range of 0.9 f₀ to 1.1 f₀, without an additional volume increase, thereby reducing the space occupied by the antennas and reducing the volume of the electronic device. The foregoing f₀ may be understood as a standard frequency, and the standard frequency may be a frequency after normalization processing.

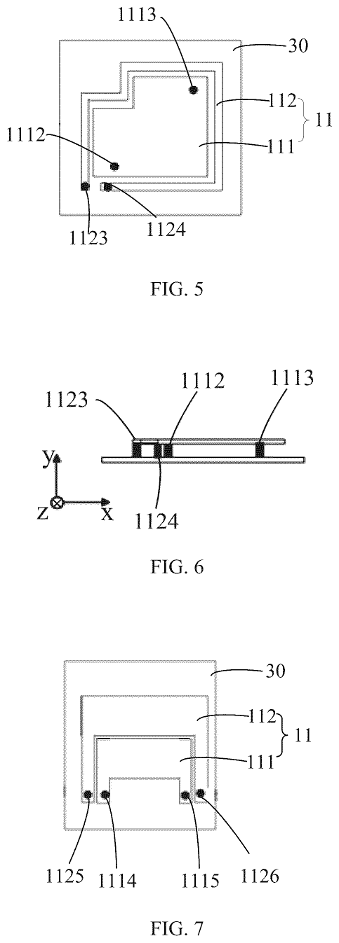

In an optional implementation, referring to FIG. 5 and FIG. 6, the first antenna 111 is provided with a third feed point 1112 and a fourth feed point 1113, the third feed point 1112 and the fourth feed point 1113 are respectively located at diagonal positions of the first antenna 111, the second antenna 112 is a loop antenna, a fifth feed point 1123 and a second ground point 1124 are arranged at two ends of the second antenna 112 respectively, and the third feed point 1112 is adjacent to and spaced apart from both the fifth feed point 1123 and the second ground point 1124.

In this implementation of this application, because the first antenna 111 is provided with the third feed point 1112 and the fourth feed point 1113, when the third feed point 1112 and the fourth feed point 1113 are connected to a feed structure that transmits feed signals of different frequency bands, the first antenna 111 can radiate radiation signals of different frequency bands under the action of the feed structure transmits emits feed signals of different frequency bands, thereby increasing the radiation bandwidth and further enhancing the radiation performance.

In addition, because the third feed point 1112 and the fourth feed point 1113 are located at the diagonal positions of the first antenna 111 respectively, a distance between the third feed point 1112 and the fourth feed point 1113 is increased, and interference between the third feed point 1112 and the fourth feed point 1113 can be reduced to further enhance the radiation performance.

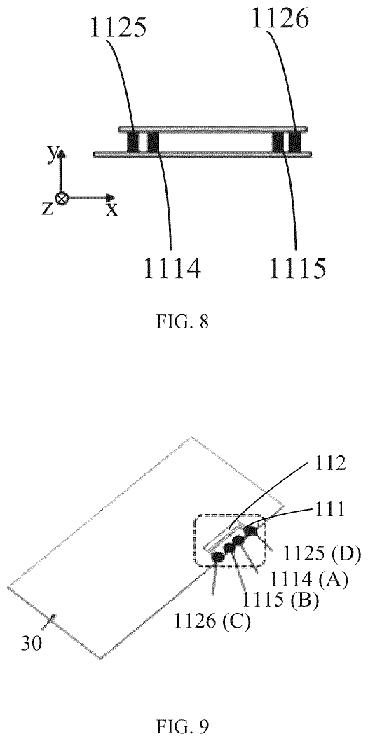

In an optional implementation, referring to FIG. 7 and FIG. 8, the first antenna 111 and the second antenna 112 are both C-shaped antennas, a sixth feed point 1114 and a seventh feed point 1115 are arranged at two ends of the first antenna 111 respectively, an eighth feed point 1125 and a ninth feed point 1126 are arranged at two ends of the second antenna 112 respectively, the sixth feed point 1114 is adjacent to and spaced apart from the eighth feed point 1125, and the seventh feed point 1115 is adjacent to and arranged opposite to the ninth feed point 1126.

In this implementation of this application, the sixth feed point 1114 and the seventh feed point 1115 are arranged at the two ends of the first antenna 111 respectively, and the eighth feed point 1125 and the ninth feed point 1126 are arranged at the two ends of the second antenna 112 respectively. In this way, both the first antenna 111 and the second antenna 112 can form a co-radiator antenna, thereby further enhancing the radiation performance and bandwidths of the first antenna 111 and the second antenna 112.

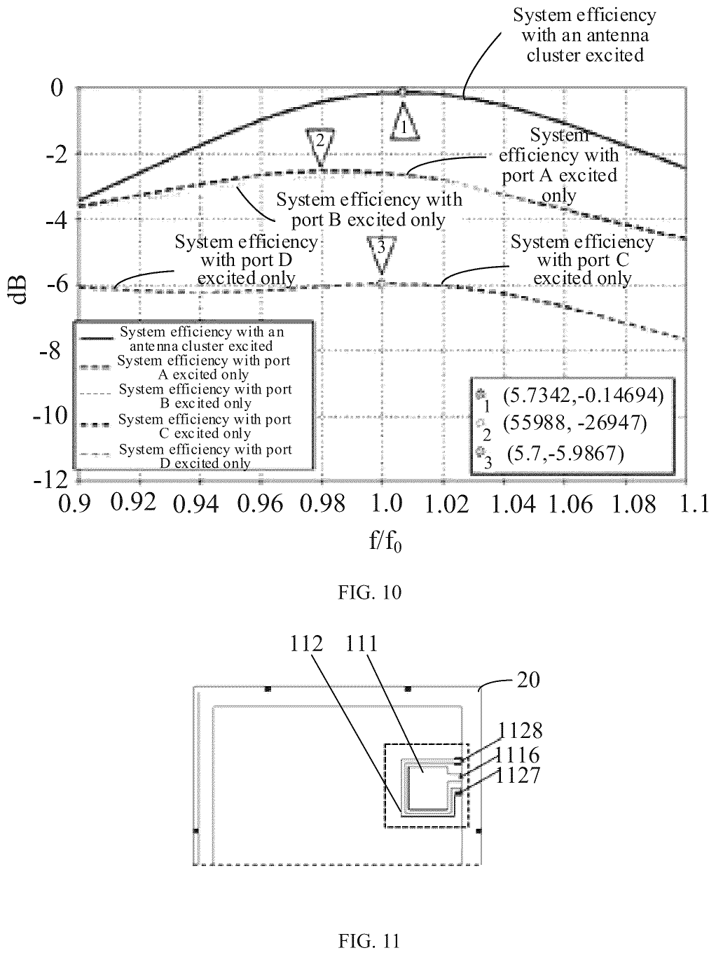

In an optional implementation, referring to FIG. 9, the antenna cluster includes two co-radiator patch antennas. A co-radiator antenna with a C-shaped structure (that is, the first antenna 111) integrates antenna A and antenna B, and is excited by port A and port B. In other words, the sixth feed point 1114 and the seventh feed point 1115 of the first antenna 111 may be referred to as port A and port B respectively. A co-radiator patch antenna with a C-shaped structure (that is, the second antenna 112) integrates antenna C and antenna D, and is excited by port C and port D. In other words, the eighth feed point 1125 and the ninth feed point 1126 of the second antenna 112 may be referred to as port C and port D respectively. Therefore, the antenna cluster has the same volume as the co-radiator antenna with the C-shaped structure, and integrates a co-radiator antenna with a rectangular structure and integrates four antenna elements. Efficiency of the antenna cluster is shown in FIG. 10, where antennas A and B operate at 0.98 f₀, and antennas C and D operate at 1.0 f₀. When only antenna A or antenna B is excited, a maximum value of system efficiency is −2.7 dB; when only antenna C or antenna D is excited, a maximum value of system efficiency is −6 dB; but when the antenna cluster is excited, a maximum value of system efficiency is −0.15 dB, which is 5.85 dB higher than that of antenna C or antenna D with the same area, and an average increase is approximately 4 dB within the range of 0.9 f₀ to 1.1 f₀. It can be learned that the antenna cluster improves the system efficiency and bandwidths of the antennas.

It should be noted that when operating frequency bands of any two of the at least two antennas are different, the antenna cluster including the at least two antennas may be referred to as an integrated inter-frequency antenna element, and the antenna cluster has a more obvious bandwidth improvement; when operating frequency bands of any two of the at least two antennas are close, the antenna cluster including the at least two antennas may be referred to as an integrated intra-frequency antenna element, and the antenna cluster has a more obvious efficiency improvement; or when the at least two antennas include a plurality of co-radiator antennas, the antenna cluster including the plurality of co-radiator antennas may be referred to as a plurality of co-radiator antenna elements, and the antenna cluster may integrate intra-frequency antenna elements and inter-frequency antenna elements and have obvious effects in improving both the bandwidth and efficiency.

For specific comparison results, refer to Table 1. A multi-antenna nesting scheme in Table 1 is a scheme in which the at least two antennas are arranged in sequence in sleeving mode and the at least two antennas are in different operating frequency bands, while a multi-co-radiator antenna nesting scheme is a scheme in which the at least two antennas include a plurality of co-radiator antennas.

TABLE 1
Beneficial effects of different antenna cluster schemes

| | | Quantity | | |
|---|---|---|---|---|
| | | of | | |
| Serial | Antenna cluster | antenna | Efficiency | Bandwidth |
| number | scheme | elements | improvement | improvement |
| a | Multi-antenna | 2 | General | Good |
| | nesting scheme | | | |
| b | Multi-co-radiator | 4 | Good | Good |
| | antenna nesting | | | |
| | scheme | | | |

In an optional implementation, referring to FIG. 11, the first antenna 111 is a rectangular antenna, the first antenna 111 is provided with a tenth feed point 1116, the second antenna 112 is a loop antenna, an eleventh feed point 1127 and a third ground point 1128 are arranged at two ends of the second antenna 112 respectively, the tenth feed point 1116 is located between the eleventh feed point 1127 and the third ground point 1128, and the tenth feed point 1116 is adjacent to and spaced apart from the eleventh feed point 1127 and the third ground point 1128 respectively.

In this implementation of this application, diversity and flexibility of the types of the first antenna 111 and the second antenna 112 can be further increased. In addition, the tenth feed point 1116 is adjacent to and spaced apart from the eleventh feed point 1127 and the third ground point 1128 respectively. In this way, the tenth feed point 1116, the eleventh feed point 1127, and the third ground point 1128 can be arranged in a centralized manner, so that sufficient clearance space can also be reserved to reduce blocking of radiation signals of the first antenna 111 and the second antenna 112, and enhance the radiation performance of the first antenna 111 and the second antenna 112.

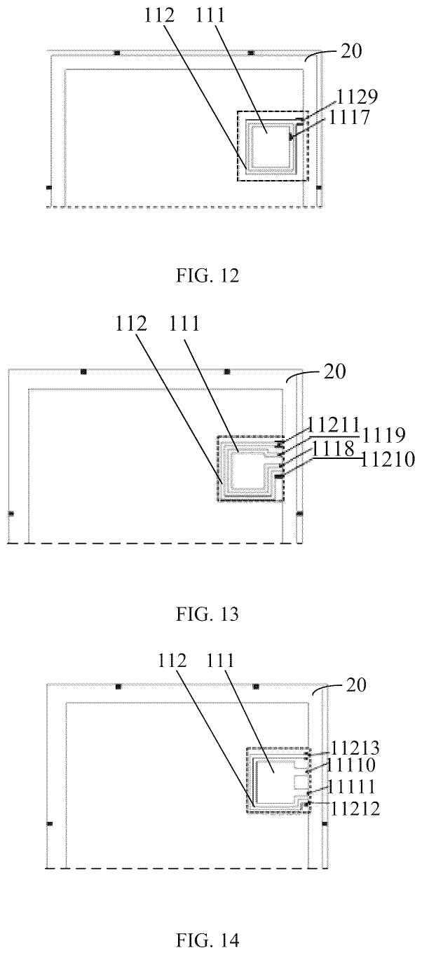

In an optional implementation, referring to FIG. 12, the first antenna 111 is a rectangular antenna, the first antenna 111 is provided with a twelfth feed point 1117, the second antenna 112 is a loop antenna, the second antenna 112 is provided with a thirteenth feed point 1129, and the twelfth feed point 1117 is adjacent to and spaced apart from the thirteenth feed point 1129.

In this implementation of this application, diversity and flexibility of the types of the first antenna 111 and the second antenna 112 can also be further increased. In addition, a quantity of feed points on the first antenna 111 and the second antenna 112 can be reduced to reduce the volume of the electronic device.

In an optional implementation, referring to FIG. 13, the first antenna 111 and the second antenna 112 are both loop antennas, a fourteenth feed point 1118 and a fourth ground point 1119 are arranged at two ends of the first antenna 111 respectively, a fifteenth feed point 11210 and a fifth ground point 11211 are arranged at two ends of the second antenna 112, and the fifth ground point 11211, the fourth ground point 1119, the fourteenth feed point 1118, and the fifteenth feed point 11210 are sequentially spaced apart.

In this implementation of this application, diversity and flexibility of the types of the first antenna 111 and the second antenna 112 can also be further increased. In addition, the fifth ground point 11211, the fourth ground point 1119, the fourteenth feed point 1118, and the fifteenth feed point 11210 are sequentially spaced apart, so that a good feeding effect and grounding effect of the first antenna 111 and the second antenna 112 can be ensured.

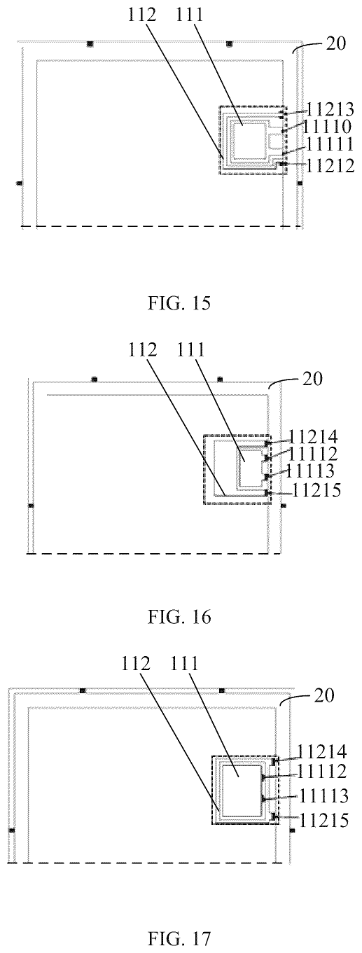

In an optional implementation, referring to FIG. 14 and FIG. 15, a sixteenth feed point 11110 and a seventeenth feed point 11111 are arranged at two ends of the first antenna 111 respectively, an eighteenth feed point 11212 and a sixth ground point 11213 are arranged at two ends of the second antenna 112 respectively, and the sixth ground point 11213, the sixteenth feed point 11110, the seventeenth feed point 11111, and the eighteenth feed point 11212 are sequentially spaced apart.

In this implementation of this application, diversity and flexibility of the types of the first antenna 111 and the second antenna 112 can also be further increased. In addition, because the sixteenth feed point 11110 and the seventeenth feed point 11111 are arranged at the two ends of the first antenna 111 respectively, the first antenna 111 is a co-radiator antenna. This increases the radiation bandwidth and improves the radiation performance. In addition, because the sixth ground point 11213, the sixteenth feed point 11110, the seventeenth feed point 11111, and the eighteenth feed point 11212 are sequentially spaced apart, interference from the second antenna 112 on the radiation performance of the first antenna 111 can be reduced.

It should be noted that the specific types of the first antenna 111 and the second antenna 112 are not limited herein.

In an optional implementation, referring to FIG. 14, the first antenna 111 is a rectangular antenna, and the second antenna 112 is a loop antenna.

In another optional implementation, referring to FIG. 15, the first antenna 111 and the second antenna 112 are both loop antennas.

Through the foregoing two implementations, diversity and flexibility of the types of the first antenna 111 and the second antenna 112 can be further increased.

In an optional implementation, referring to FIG. 16 and FIG. 17, a nineteenth feed point 11112 and a twentieth feed point 11113 are arranged at two ends of the first antenna 111 respectively, a twenty-first feed point 11214 and a twenty-second feed point 11215 are arranged at two ends of the second antenna 112 respectively, and the twenty-first feed point 11214, the nineteenth feed point 11112, the twentieth feed point 11113, and the twenty-second feed point 11215 are sequentially spaced apart.

In this implementation of this application, diversity and flexibility of the types of the first antenna 111 and the second antenna 112 can also be further increased. In addition, the nineteenth feed point 11112 and the twentieth feed point 11113 are arranged at the two ends of the first antenna 111 respectively, and the twenty-first feed point 11214 and the twenty-second feed point 11215 are arranged at the two ends of the second antenna 112 respectively. In this way, the first antenna 111 and the second antenna 112 are both co-radiator antennas, thereby further increasing the radiation bandwidth and improving the radiation performance of the first antenna 111 and the second antenna 112. In addition, because the twenty-first feed point 11214, the nineteenth feed point 11112, the twentieth feed point 11113, and the twenty-second feed point 11215 are sequentially spaced apart, mutual interference between the first antenna 111 and the second antenna 112 can also be reduced.

It should be noted that the specific types of the first antenna 111 and the second antenna 112 are not limited herein.

In an optional implementation, referring to FIG. 16, the first antenna is a rectangular antenna, and the second antenna is a C-shaped antenna.

In another optional implementation, referring to FIG. 17, the first antenna is a rectangular antenna, and the second antenna is a loop antenna.

Through the foregoing two implementations, diversity and flexibility of the types of the first antenna 111 and the second antenna 112 can be further increased.

It should be noted that in the foregoing implementations, when the first antenna 111 is provided with two feed points, and the two feed points are electrically connected to two feed structures respectively, the first antenna 111 may be referred to as a co-radiator antenna, and operating frequency bands of the two feed structures connected to the first antenna 111 may be close or may not be close. In addition, the two feed structures connected to the first antenna 111 may feed the first antenna 111 at the same time, or the two feed structures connected to the first antenna 111 may feed the first antenna 111 in different time periods (that is, the two feed structures feed the first antenna 111 in different time periods respectively).

When the two feed structures connected to the first antenna 111 feed the first antenna 111 at the same time, and the operating frequency bands of the two feed structures are close, the radiation efficiency of the first antenna 111 can be further enhanced without increasing the quantity of antennas.

When the two feed structures connected to the first antenna 111 feed the first antenna 111 in different time periods, and the operating frequency bands of the two feed structures are not close, the bandwidth of the first antenna 111 can be further increased without increasing the quantity of antennas.

In other words, because the first antenna 111 is a co-radiator antenna, the radiation efficiency and bandwidth of the first antenna 111 can be further enhanced without increasing the quantity of antennas.

It should be noted that, with reference to the foregoing description, when the second antenna 112 is electrically connected to two feed structures respectively, the second antenna 112 may also be a co-radiator antenna.

When the first antenna 111 and the second antenna 112 are both co-radiator antennas, the operating frequencies of the first antenna 111 and the second antenna 112 may be different, thereby further increasing the bandwidths of the antennas of the electronic device.

Because the first antenna 111 and the second antenna 112 are both co-radiator antennas, the radiation efficiency and bandwidth of the first antenna 111 and the radiation efficiency and bandwidth of the second antenna 112 can be further enhanced without increasing the quantity of antennas, and the radiation efficiency and bandwidths of the antennas can be further enhanced without increasing the volume of the electronic device, to further enhance the radiation performance of the antennas.

In the description of this specification, the description referring to the terms “an embodiment”, “some embodiments”, “exemplary embodiments”, “an example”, “a specific example”, or “some examples” means a specific feature, structure, material or characteristic described with reference to the embodiment or example is included in at least one embodiment or example of the this application. In this specification, illustrative expressions of these terms do not necessarily refer to the same embodiment or example. Moreover, the specific feature, structure, material, or characteristic described may be combined in any suitable manner in any one or more embodiments or examples.

Although the embodiments of this application have been shown and described, those of ordinary skill in the art can understand that various changes, modifications, substitutions, and variants of these embodiments may be made without departing from the principles and purposes of this application, and the scope of this application is limited by the claims and their equivalents.

1. An electronic device, comprising an antenna cluster, wherein the antenna cluster comprises at least two antennas arranged in sequence, each antenna corresponds to a feed point, the feed point is electrically connected to a feed structure, any two adjacent antennas of the at least two antennas are at least partially arranged in sleeving mode, and any two adjacent antennas of the at least two antennas are spaced apart.

2. The electronic device according to claim 1, wherein the electronic device comprises a main board, a cover plate, and a frame, wherein the main board and the cover plate are spaced apart, an accommodating cavity is formed and enclosed by the main board, the cover plate, and the frame, the antenna cluster is located in the accommodating cavity, the feed structure corresponding to each antenna comprised in the antenna cluster is located on the main board, and a radiator of each antenna comprised in the antenna cluster is arranged toward the cover plate.

3. The electronic device according to claim 1, wherein the at least two antennas comprise a first antenna and a second antenna, and the first antenna is at least partially arranged in the second antenna in sleeving mode.

4. The electronic device according to claim 3, wherein the first antenna is a patch antenna, a first feed point is arranged in a first corner position of the first antenna, the second antenna is a loop antenna, a second feed point and a first ground point are arranged at two ends of the second antenna respectively, and any two of the first feed point, the second feed point, and the first ground point are adjacent and spaced apart.

5. The electronic device according to claim 3, wherein the first antenna is provided with a third feed point and a fourth feed point, the third feed point and the fourth feed point are respectively located at diagonal positions of the first antenna, the second antenna is a loop antenna, a fifth feed point and a second ground point are arranged at two ends of the second antenna respectively, and the third feed point is adjacent to and spaced apart from both the fifth feed point and the second ground point.

6. The electronic device according to claim 3, wherein the first antenna and the second antenna are both C-shaped antennas, a sixth feed point and a seventh feed point are arranged at two ends of the first antenna respectively, an eighth feed point and a ninth feed point are arranged at two ends of the second antenna respectively, the sixth feed point is adjacent to and spaced apart from the eighth feed point, and the seventh feed point is adjacent to and arranged opposite to the ninth feed point.

7. The electronic device according to claim 3, wherein the first antenna is a rectangular antenna, the first antenna is provided with a tenth feed point, the second antenna is a loop antenna, an eleventh feed point and a third ground point are arranged at two ends of the second antenna respectively, the tenth feed point is located between the eleventh feed point and the third ground point, and the tenth feed point is adjacent to and spaced apart from the eleventh feed point and the third ground point respectively.

8. The electronic device according to claim 3, wherein the first antenna is a rectangular antenna, the first antenna is provided with a twelfth feed point, the second antenna is a loop antenna, the second antenna is provided with a thirteenth feed point, and the twelfth feed point is adjacent to and spaced apart from the thirteenth feed point.

9. The electronic device according to claim 3, wherein the first antenna and the second antenna are both loop antennas, a fourteenth feed point and a fourth ground point are arranged at two ends of the first antenna respectively, a fifteenth feed point and a fifth ground point are arranged at two ends of the second antenna, and the fifth ground point, the fourth ground point, the fourteenth feed point, and the fifteenth feed point are sequentially spaced apart.

10. The electronic device according to claim 3, wherein a sixteenth feed point and a seventeenth feed point are arranged at two ends of the first antenna respectively, an eighteenth feed point and a sixth ground point are arranged at two ends of the second antenna respectively, and the sixth ground point, the sixteenth feed point, the seventeenth feed point, and the eighteenth feed point are sequentially spaced apart.

11. The electronic device according to claim 10, wherein the first antenna is a rectangular antenna, and the second antenna is a loop antenna.

12. The electronic device according to claim 10, wherein the first antenna and the second antenna are both loop antennas.

13. The electronic device according to claim 3, wherein a nineteenth feed point and a twentieth feed point are arranged at two ends of the first antenna respectively, a twenty-first feed point and a twenty-second feed point are arranged at two ends of the second antenna respectively, and the twenty-first feed point, the nineteenth feed point, the twentieth feed point, and the twenty-second feed point are sequentially spaced apart.

14. The electronic device according to claim 13, wherein the first antenna is a rectangular antenna, and the second antenna is a C-shaped antenna.

15. The electronic device according to claim 13, wherein the first antenna is a rectangular antenna, and the second antenna is a loop antenna.

16. The electronic device according to claim 1, wherein there are a plurality of antenna clusters, and the plurality of antenna clusters are located at different positions of the electronic device.
